(19) United States
(12) Patent Application Publication
(10) Pub. No.: US 2011/0016389 A1
(43) Pub. Date: Jan. 20, 2011

(54) BI-DIRECTIONAL TEXT CONTRACTION AND EXPANSION

(75) Inventors: Glen GORDON, Madison, WI (US); Jonathan Mosen, Wellington (NZ)

Correspondence Address: FOLEY & LARDNER LLP, 111 HUNTINGTON AVENUE, 26TH FLOOR, BOSTON, MA, 02199-7610, US

(73) Assignee: Freedom Scientific, Inc.

(21) Appl. No.: 12/503,362

(22) Filed: Jul. 15, 2009

(51) Int. Cl. G06F 17/24

(52) U.S. Cl. 715/271; 715/256

(57) ABSTRACT

The technology is directed to bi-directional text contraction and expansion. In some embodiments, a defined field is determined based on a focus location and the focus location is associated with a location of the defined field in a user interface. Expanded text associated with the defined field is determined, and the expanded text is contracted based on a first context of at least one part of the expanded text. Modified contracted text is received, and the modified contracted text is associated with the defined field.

### FIELD OF THE INVENTION

The present invention relates generally to computer-based methods and apparatuses, including computer program products, for bi-directional text contraction and expansion.

### BACKGROUND

In operating systems for computer program products, a screen reader makes itself a ubiquitous part of the operating system (OS). In some operating systems, the screen reader intercepts window messages for all applications and intercepts all text and graphics written to the screen by redirecting display driver calls to the screen reader. These interceptions and/or OS specific accessibility interfaces/application specific object models allow the screen reader to output speech and Braille from applications without the direct cooperation of those applications. The screen reader presents information verbally by utilizing a text to speech engine, and in Braille, via a single-line refreshable Braille display. The line lengths of the Braille display models range between 20 and 80 characters.

Computer Braille represents each character as a single Braille cell and Grade II Braille (also referred to as literary Braille) includes Braille symbols that each represent a combination of multiple characters. In most cases, a Grade II Braille representation of text requires fewer Braille cells than a Computer Braille representation.

Some computer programs allow for Grade II Braille input of text and storage of this text in its contracted form. However, the storage of contracted text is only appropriate in the case where the only user of such text is a blind user reading Braille. For all other users, such a file will appear mostly as random characters (i.e., the characters that represent the Grade II contractions). These computer programs are essentially text editors that allow Braille entry within an environment that the computer program totally controls. Thus, a need exists to improve text contraction and expansion in this technology field.

### SUMMARY

One approach to bi-directional text contraction and expansion is a method. The method includes determining a defined field based on a focus location. The focus location is associated with a location of the defined field in a user interface. The method further includes determining expanded text associated with the defined field and contracting the expanded text based on a first context of at least one part of the expanded text. The method further includes receiving modified contracted text, the modified contracted text associated with the defined field.

Another approach to bi-directional text contraction and expansion is another method. The method includes determining a defined field based on a focus location associated with a user interface. The method further includes receiving contracted text. The contracted text is associated with the defined field. The method further includes expanding the contracted text based on a context of at least one part of the contracted text and a second focus location and storing the expanded text at a storage location in a storage device. The storage location is associated with the defined field.

Another approach to bi-directional text contraction and expansion is a computer program product. The computer program product is tangibly embodied in an information carrier. The computer program product includes instructions being operable to cause a data processing apparatus to determine a defined field based on a focus location, the focus location associated with a location of the defined field in a user interface; determine expanded text associated with the defined field; contract the expanded text based on a first context of at least one part of the expanded text; and receive modified contracted text, the modified contracted text associated with the defined field.

Another approach to bi-directional text contraction and expansion is a system. The system includes a display module, a text module, a contraction module, and an input module. The display module is configured to determine a defined field based on a focus location. The focus location is associated with a location of the defined field in a user interface. The text module is configured to determine expanded text associated with the defined field. The contraction module is configured to contract the expanded text based on a first context of at least one part of the expanded text. The input device is configured to receive modified contracted text, the modified contracted text associated with the defined field.

Another approach to bi-directional text contraction and expansion is a system. The system includes a display module, an input device, an expansion module, and a storage device. The display module is configured to determine a defined field based on a focus location associated with a user interface. The input device is configured to receive contracted text. The contracted text is associated with the defined field. The expansion module is configured to expand the contracted text based on a context of at least one part of the contracted text and a second focus location. The storage device is configured to store the expanded text at a storage location. The storage location is associated with the defined field.

Another approach to bi-directional text contraction and expansion is a system. The system includes a means for determining a defined field based on a focus location. The focus location is associated with a location of the defined field in a user interface. The system further includes a means for determining expanded text associated with the defined field; a means for contracting the expanded text based on a first context of at least one part of the expanded text; and a means for receiving modified contracted text, the modified contracted text associated with the defined field.

In other examples, any of the approaches above can include one or more of the following features. In some examples, the modified contracted text is expanded based on a second context of at least one part of the modified contracted text. The modified expanded text is stored in a storage device.

In some examples, the storing the modified expanded text includes determining a storage location of the expanded text stored at the storage device; and replacing the expanded text stored at the storage location at the storage device with the modified expanded text.

In other examples, the contracted text is displayed in the defined field.

In some examples, the first context of at least one part of the expanded text is determined based on the text on at least one side of the part of the expanded text.

In other examples, the defined field is determined based on a display of the expanded text in the user interface. The expanded text includes part of an expanded text file.

In some examples, the modified contracted text is expanded based on a second context of at least one part of the modified contracted text and the modified expanded text is stored in a temporary storage device.

In other examples, a focus location request is received based on a second focus location. The second focus location is associated with a second location in the user interface. A storage location of the expanded text stored at a storage device is determined. The expanded text stored at the storage location at the storage device is replaced with the modified expanded text stored in the temporary storage device based on the focus location request.

In some examples, a focus location request is received in the user interface. A storage location of the expanded text in the storage device is determined based on the focus location request.

In other examples, the context of at least one part of the contracted text is determined based on the text on at least one side of the part of the contracted text.

In some examples, the defined field is determined based on text at an end of the contracted text.

In other examples, an expansion module is configured to expand the modified contracted text based on a second context of at least one part of the modified contracted text; and a storage device is configured to store the modified expanded text.

In some examples, a temporary storage device is configured to store a modified contracted text; and an expansion module is configured to expand the modified contracted text based on a second context of at least one part of the modified contracted text.

In other examples, the display module is configured to receive a focus location request based on a second focus location. The second focus location is associated with a second location in the user interface. A storage device is configured to determine a storage location of the expanded text; and replace the expanded text stored at the storage location with the modified expanded text stored in the temporary storage device based on the focus location request.

In some examples, the expansion module is configured to determine the context of at least one part of the contracted text based on the text on at least one side of the part of the contracted text.

The bi-directional text contraction and expansion techniques described herein can provide one or more of the following advantages. An advantage of the bi-directional text contraction and expansion is users can input and/or edit text in contracted Braille while other users can input and/or edit text in uncontracted Braille or plain text, thereby increasing the efficiency of both the contracted Braille users and the uncontracted Braille users. Another advantage to the bi-directional text contraction and expansion is that the defined field (e.g., a text box, a line in a text file, a word, etc.) is translated in parts when focus location changes, thereby enabling the integration of the contraction and expansion system into any application without customization of the application.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a block diagram of an exemplary bi-directional text contraction and expansion system;

FIG. 2 is a block diagram of another exemplary bi-directional text contraction and expansion system;

FIGS. 3A-3E depict exemplary user interfaces;

FIGS. 4A-4F depict other exemplary user interfaces;

FIGS. 5A-5B depict an exemplary flowchart of contracted Braille contraction and expansion; and

FIG. 6 depicts another exemplary flowchart of contracted Braille contraction and expansion.

### DETAILED DESCRIPTION

As a general overview of the technology, when a user focuses on a defined field (e.g., a text box, a line in a text file, a word, etc.) in a user interface, the technology determines if the defined field already includes text (e.g., contracted Braille, plain text, etc.). If the defined field does not already include text, the technology enables the input of Braille in Grade II form (also referred to as contracted Braille) with the storage of the input in uncontracted form (e.g., uncontracted Braille, plain text, etc.). If the defined field already includes text, the technology enables the editing of the text in contracted Braille and the storage of the modified input in uncontracted form. The technology advantageously enables a user to input and/or edit text in contracted Braille while storing the text in uncontracted Braille and/or plain text for use by other users of the application, thereby increasing the efficiency of all users via the automated process. For example, a customer service representative at a call center can input an order from a customer in an order application using contracted Braille and a quality service representative can modify the order in the order application using uncontracted Braille.

As a general example of the technology, a user focuses on an empty text box and inputs contracted Braille—“,two degrees abv gd4”—utilizing an input device (e.g., Perkins-style Braille keyboard, QWERTY keyboard, a speech to text module, a touch screen keyboard, etc.). When the user changes the focus location in the user interface (e.g., moves the cursor (also referred to as a caret), changes the active window, hits Enter, etc.), the contracted Braille text is expanded into uncontracted Braille text—“Two degrees above good.”—and the uncontracted Braille text is stored as the input into the application. In other words, the uncontracted Braille text is provided as the standard input into the application. This expansion of the contracted Braille text to uncontracted Braille text can also be referred to as “back translation.”

As a further general example of the technology, a user focuses on a text box with uncontracted Braille text—“Every friend needs two other friends.” The uncontracted Braille text is retrieved and contracted into contracted Braille text—“,e fr ne$s two o!r frs4” The user edits the contracted Braille text utilizing an input device—“,e fr ne$s a hug6”—and changes the focus location in the user interface (in this example, the user hits Enter). The modified contracted Braille text is expanded—“Every friend needs a hug!”—and the modified uncontracted Braille text replaces the original uncontracted Braille text in the text box. In other words, the modified uncontracted Braille text overwrites the original uncontracted Braille text in the text box and any storage locations associated with the text box (in this example, the storage location in main memory assigned to the text box). This contraction of the uncontracted Braille text to contracted Braille text can also be referred to as “forward translation.”

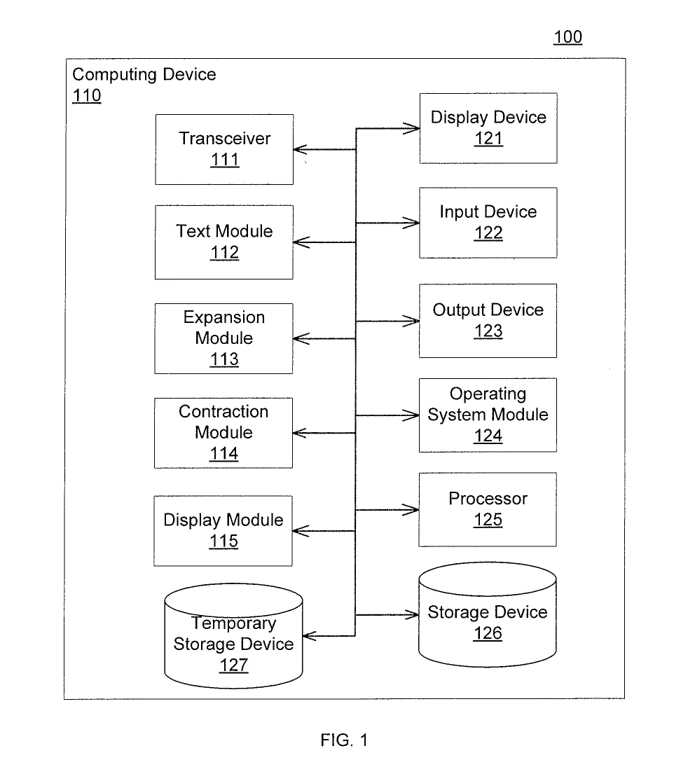

FIG. 1 is a block diagram of an exemplary bi-directional text contraction and expansion system 100. The system 100 includes a computing device 110. The computing device 110 includes a transceiver 111, a text module 112, an expansion module 113, a contraction module 114, a display module 115, a display device 121, an input device 122, an output device 123, an operating system module 124, a processor 125, a storage device 126, and a temporary source device 127. The modules and devices described herein can, for example, utilize the processor 125 to execute computer executable instructions and/or include a processor to execute computer executable instructions (e.g., a graphic processing unit, a field programmable gate array processing unit, etc.). It should be understood that the computing device 110 can include, for example, other modules, devices, and/or processors known in the art.

The transceiver 111 transmits and/or receives data to/from the computing device 110. The text module 112 determines expanded text (e.g., uncontracted Braille text, plain text, etc.) associated with the defined field. The contraction module 114 contracts expanded text based on a context of at least one part of the expanded text.

The display module 115 determines a defined field based on a focus location and/or receives a focus location request based on a different focus location. The focus location can be, for example, associated with a location in a user interface. For example, the focus location is an active window that is active based on the location of the cursor in the user interface. The focus location can be, for example, depicted on the display of the user interface, for example, via the cursor location, the active window, etc. The change in focus location can be, for example, associated with an operating system message to change the location of the cursor, an operating system message to activate a new window in the user interface, and/or any other type of change in the user interface. Each focus location can be, for example, associated with a location of the defined field in a user interface (e.g., cursor location, active window, mouse pointer, etc.). In some examples, the user interface is displayed in the display device 121 and/or in parts via the output device 123 (e.g., Braille display, Braille printer, etc.). In other examples, the user interface is accessed via the input device 122 without being displayed on any type of display device 121 (e.g., the user interacts with the user interface via a Perkins-style Braille keyboard, etc.).

The display device 121 displays text and/or graphics (e.g., monitor, television, etc.).

The input device 122 receives contracted text (e.g., original, modified, etc.) from a user. The contracted text is associated with the defined field, for example, the modified contracted text replaces the contracted text in the defined field. The expansion module 113 expands contracted text (e.g., original, modified, etc.) based on a context of at least one part of the contracted text (e.g., one character, a group of characters, a word, a group of words, etc.) and/or a focus location.

The output device 123 outputs text, for example, to, a Braille output device, a text to speech device, etc. The operating system module 124 interacts with an operating system, for example, to intercept messages, modify a message, transmit a message, etc. The processor 125 executes the operating system and/or any other executable programs for the computing device 110 (e.g., executes applications, etc.)

The storage device 126 stores text (e.g., expanded text, contracted text, modified expanded text, modified contracted text, etc.) and/or any other data (e.g., user preferences, application data, etc.). The temporary storage device 127 also stores text (e.g., expanded text, contracted text, modified expanded text, modified contracted text, etc.) and/or any other data (e.g., user preferences, application data, etc.). However, the temporary storage device 127 can be a buffer enabling the text and/or data to be temporary modified without overwriting the original text and/or data stored in the storage device 126. For example, the temporary storage device 127 stores the contracted text for editing while the uncontracted text is stored in the storage device 127.

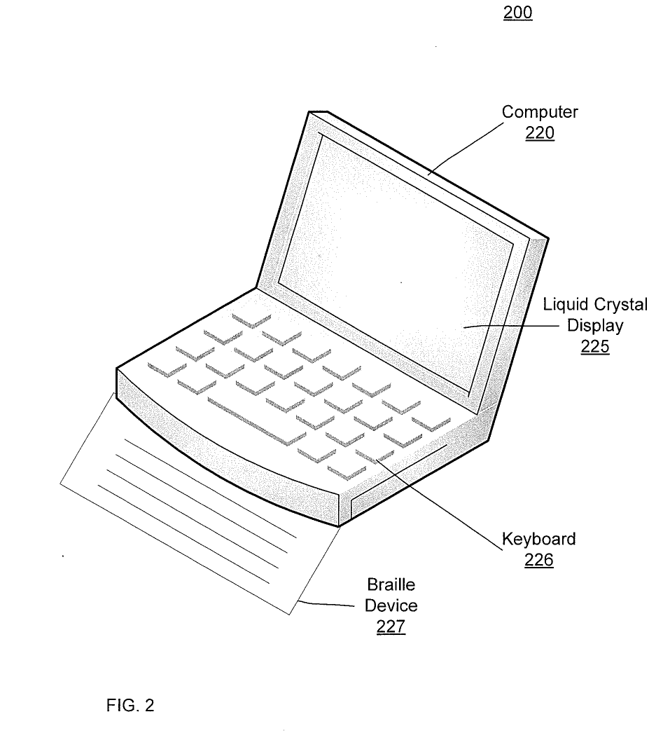

FIG. 2 is a block diagram of another exemplary bi-directional text contraction and expansion system 200. The system 200 includes a computer 220. The computer 220 includes a liquid crystal display (LCD) 225, a keyboard 226, and a Braille output device 227. The computer 220 contracts and expands text, outputs any form of the text to the LCD 225 and/or the Braille output device 227, and receives input from the keyboard 226. It should be understood that any of the features and/or techniques described herein can be implemented utilizing the computer 220.

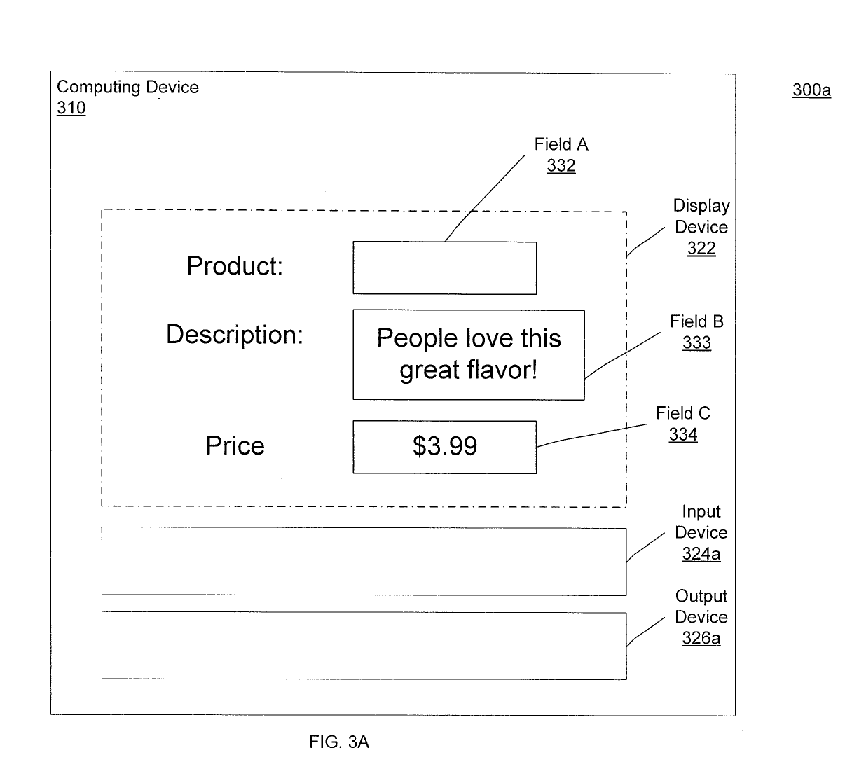

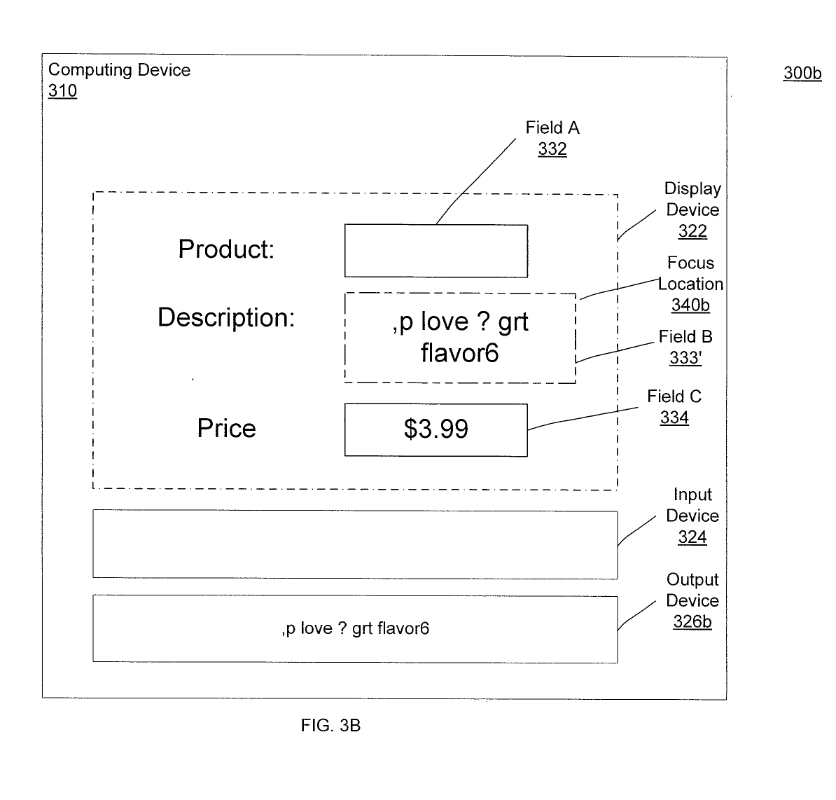

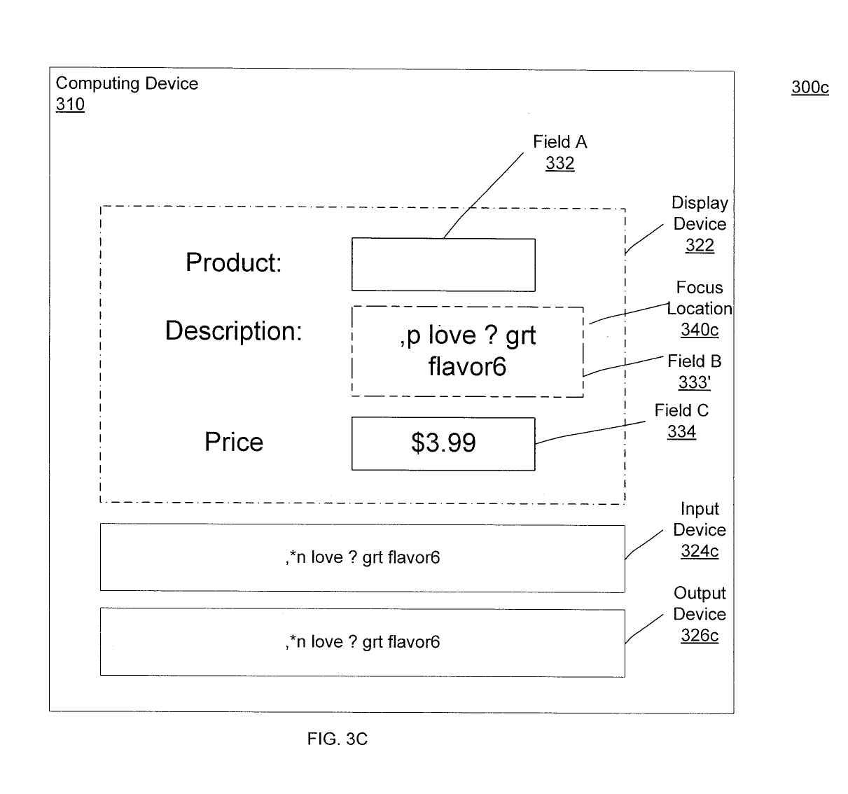

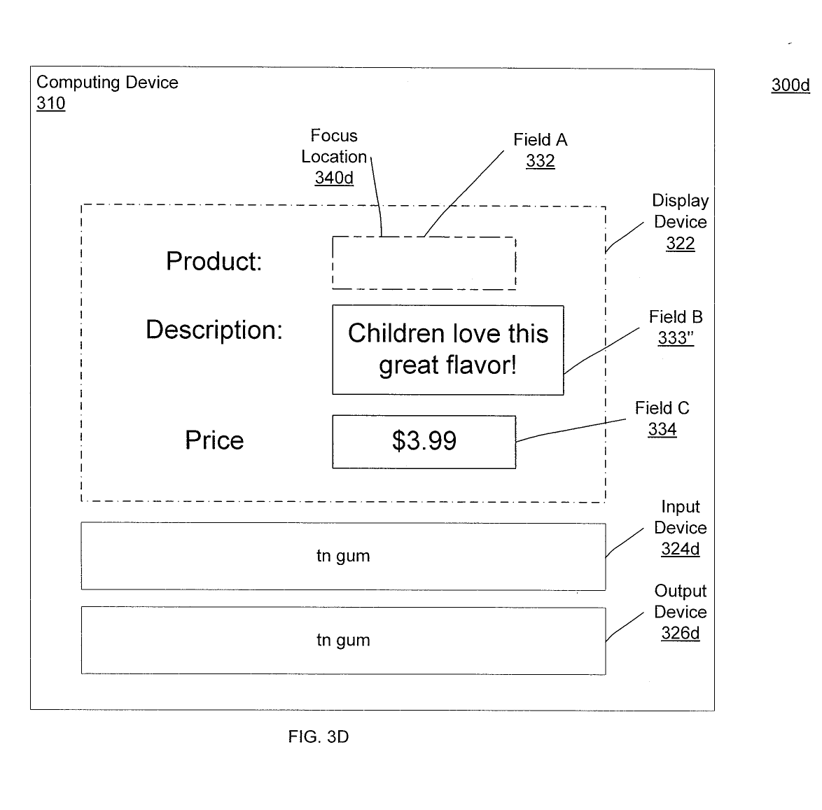

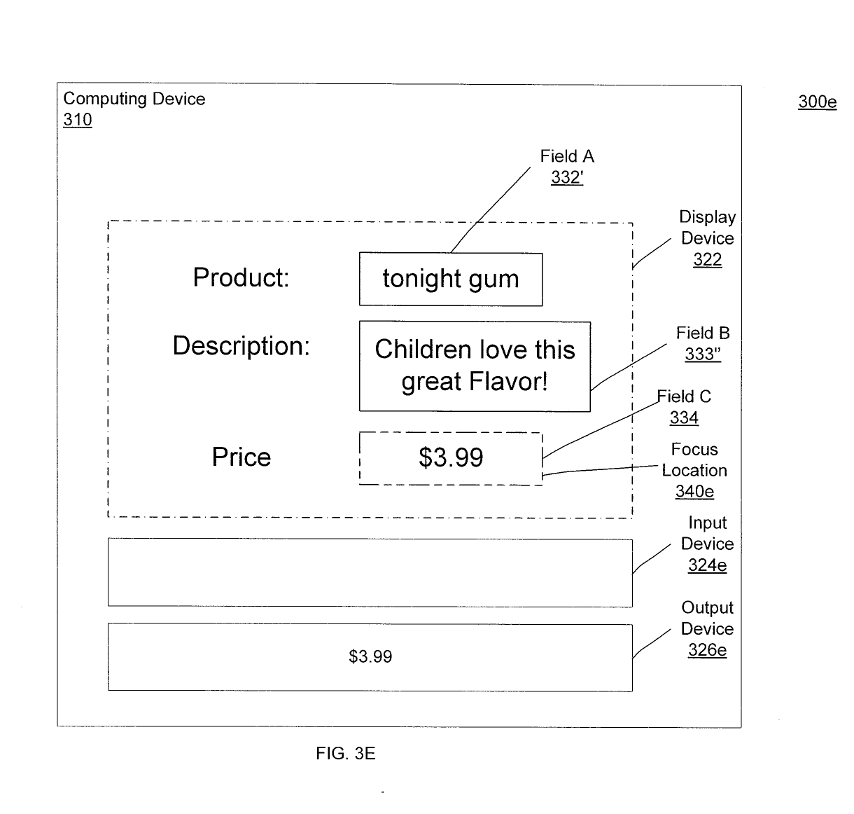

FIGS. 3A-3E depict exemplary user interfaces 300a-300e that utilize a computing device 310. Generally, in the user interfaces 300a-300e, the computing device 310 includes a display device 322, an input device 324, and an output device 326. The display device 322 displays a product field A 332, a description field B 333 and a price field C 334. The user can interact with the user interfaces 300a-300e to access an application (e.g., word processor, spreadsheet, web browser, accounting application, order entry application, calculator, etc.) and/or the operating system and can focus on a location in the user interface via a focus location 340.

FIG. 3A depicts the exemplary user interface 300a. The input device 324a and the output device 326a are empty in the user interface 300a since there is not an active focus location, for example, the user has not selected a dialog box or window.

FIG. 3B depicts the exemplary user interface 300b. In the user interface 300b, the focus location 340b is set to the description field B 333 based on the user selecting the description field B 333 utilizing the user interface (e.g., the user tabs to the description field B 333, the user selects the description field B 333 using a mouse, etc.). The display module 115 of FIG. 1 determines the defined field based on the focus location 340b. For example, the focus location 340b is at a set of coordinates in the user interface and the display module 115 queries the application and/or the operating system to determine what is at that set of coordinates (in this example, the description field B 333 is at the set of coordinates of the focus location).

Based on the focus location 340b, the text module 112 determines expanded text associated with the defined field (in this example, “People love this great flavor!”). For example, the text module 112 captures the expanded text for all transactions between the application and the operating system and determines the expanded text based on the capture of the transactions (e.g., the text module 112 stores the captures expanded text by location in the user interface and determines the expanded text based on the focus location in the user interface). For example, the text module 112 queries the application and/or the operating system to determine the expanded text associated with product field B 333 (e.g., the text module 112 sends a window refresh query to the application requesting a refresh of the text in the defined field). As another example, the text module 112 analyzes the user interface 330b to determine the expanded text from the data in the video memory (e.g., data at video memory 0×23b).

The contraction module 114 contracts the expanded text based on the context of at least one part of the expanded text (in this example, “,p love ? grt ,flavor6”). The display module 115 outputs the contracted text to the description field B 333′ via the display device, and the output device 326b outputs the contracted text (e.g., outputs the contracted text in contracted Braille via a Braille output device).

FIG. 3C depicts the user interface 300c. In the user interface 300c, the focus location 340c is set to the description field B 333′. The input device 324c receives modified contracted text—“,*n love ? grt flavor6” The modified contracted text can be output to the output device 326c (e.g., for confirmation of the input).

FIG. 3D depicts the user interface 300d. In the user interface 300d, the focus location 340d is set to the product field A 332. When the focus location changes from focus location 340c in user interface 300c to the focus location 340d in the user interface 300d, the expansion module 113 expands the modified contracted text received from the input device 324c for the description field B 333′ based on a context of at least one part of the modified contracted text—“Children love this great flavor!” The computing device 310 stores the modified expanded text (e.g., overwrites the original expanded text). As illustrated in the user interface 300d, the description field B 333″ displays the modified expanded text—“Children love this great flavor!”

When the focus location 340c changed to the focus location 340d based on the user's interaction with the user interface (e.g., hitting enter, moving the mouse cursor, etc.), the display module 115 determines the defined field (in this example, the product field A 332) based on the focus location 340d. The text module 112 determines that the product field A 332 does not include any text.

The input device 324d receives input—“tn gum”—based on the user's interaction with the input device 324d (e.g., Perkins Braille keyboard input, speech to text input, etc.). The input can be output to the output device 326d.

FIG. 3E depicts the user interface 300e. In the user interface 300e, the focus location 340e is set to the price field C 334. When the focus location changes from focus location 340d in user interface 300d to the focus location 340e in the user interface 300e, the expansion module 113 expands the modified contracted text received from the input device 324d for the product field A 332 based on a context of at least one part of the modified contracted text—“tonight gum”. The computing device 310 stores the modified expanded text in the storage device 126. As illustrated in the user interface 300e, the price field A 332′ displays the modified expanded text—“tonight gum”.

When the focus location 340d changed to the focus location 340e based on the user's interaction with the user interface, the display module 115 determines the defined field (in this example, the price field C 334) based on the focus location 340e. The text module 112 determines that the price field C 334 includes expanded text and retrieves the expanded text—“$3.99”—(e.g., from video memory, from main memory, from hard drive, etc.). The output device 326e outputs the expanded text.

In other examples, the contraction module 114 contracts the expanded text based on the context of at least one part of the expanded text by separating each word of the expanded text based on the spaces between the words and the punctuation (in this example, “People” “love” “this” “great” “flavor” “!”). The contraction module 114 can analyze, for example, each word individually to determine if the word can be contracted utilizing a list of contractions (e.g., a look-up table, a tree, etc.). For example, the contraction module 114 searches the list of contractions for the expanded word “People” and based on the results of the search, the expanded word “People” is contracted to “,p”.

In some examples, the translation of text (e.g., expansion of contracted text, contraction of expanded text, etc.) is context dependent since the pairing of letters can represent different words. For example, the Braille letter “c” when surrounded by white space represents the word “can” and when paired with the letter “cd” represents the word “could” and when followed by any other letter represents itself. In other words, at the time a character is entered, the translated text cannot be determined. The technology advantageously enables the translation of parts of text by analyzing the defined field in its totality instead of translating single characters thereby enabling the integration of the technology into any application without customization of the application.

In some examples, the focus location 340b can be set based on a user's interaction with the user interface 300b (e.g., a user selects the product field B 333 using a mouse, a user tabs to the product field B 333 using a keyboard, etc.).

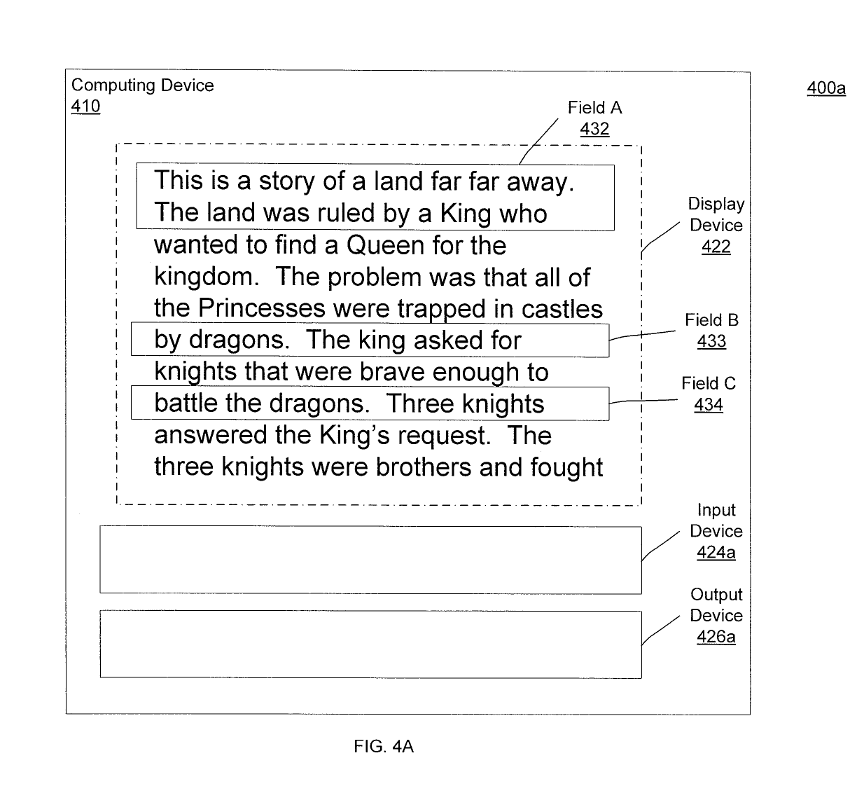

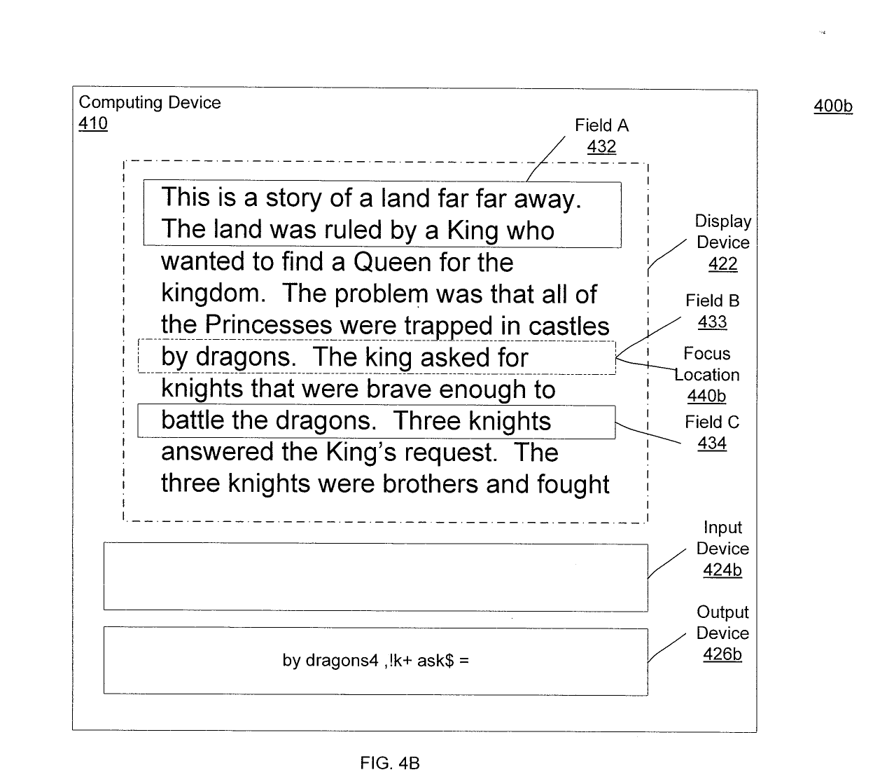

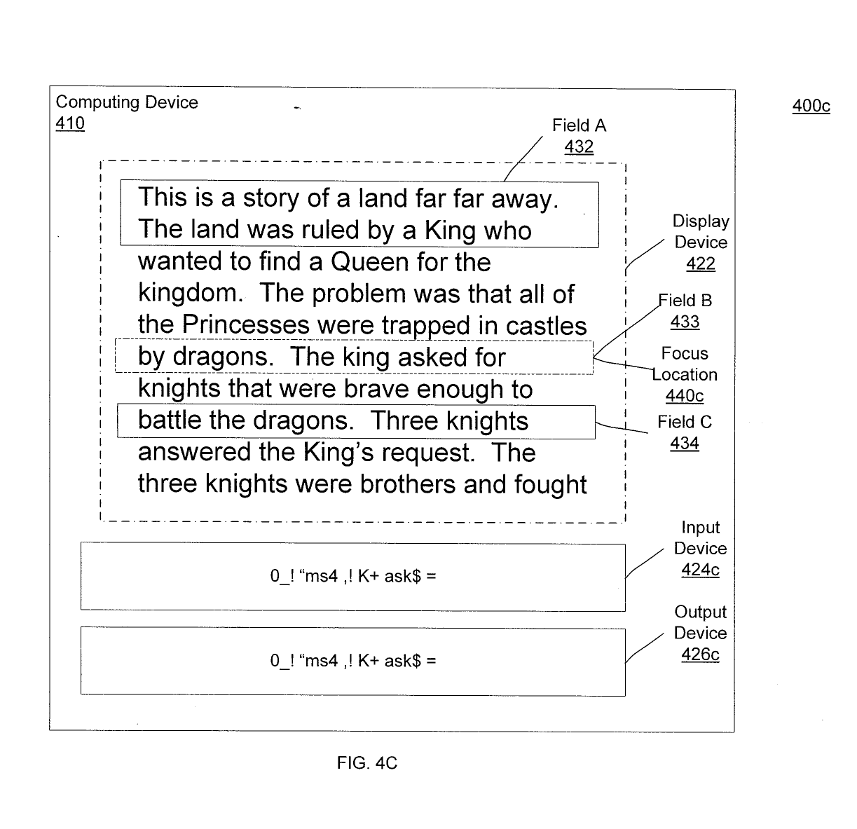

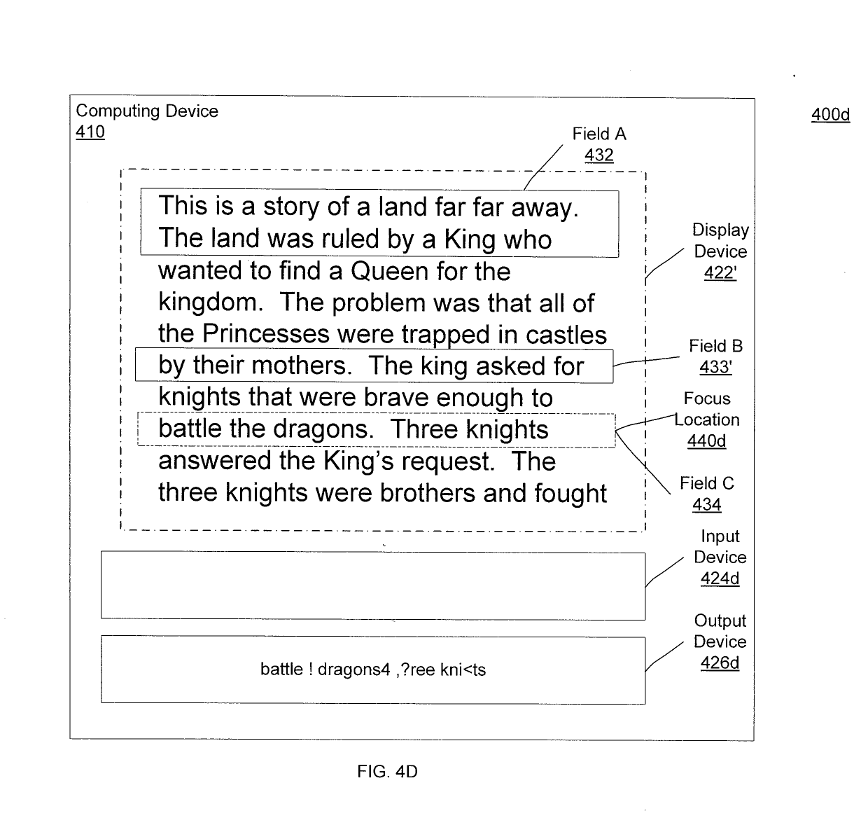

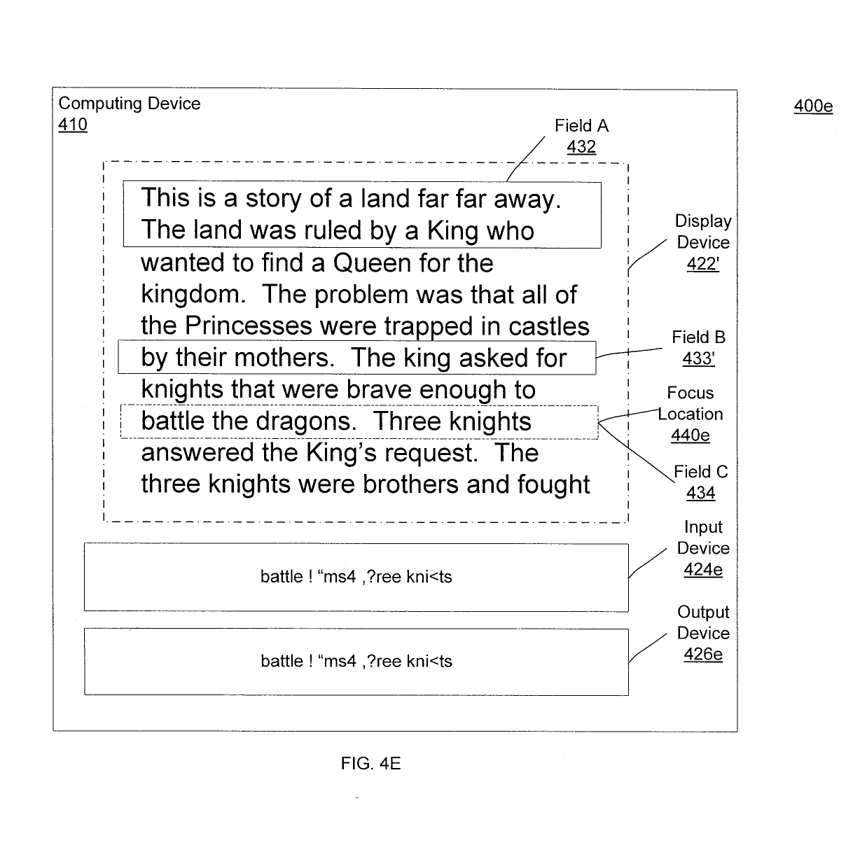

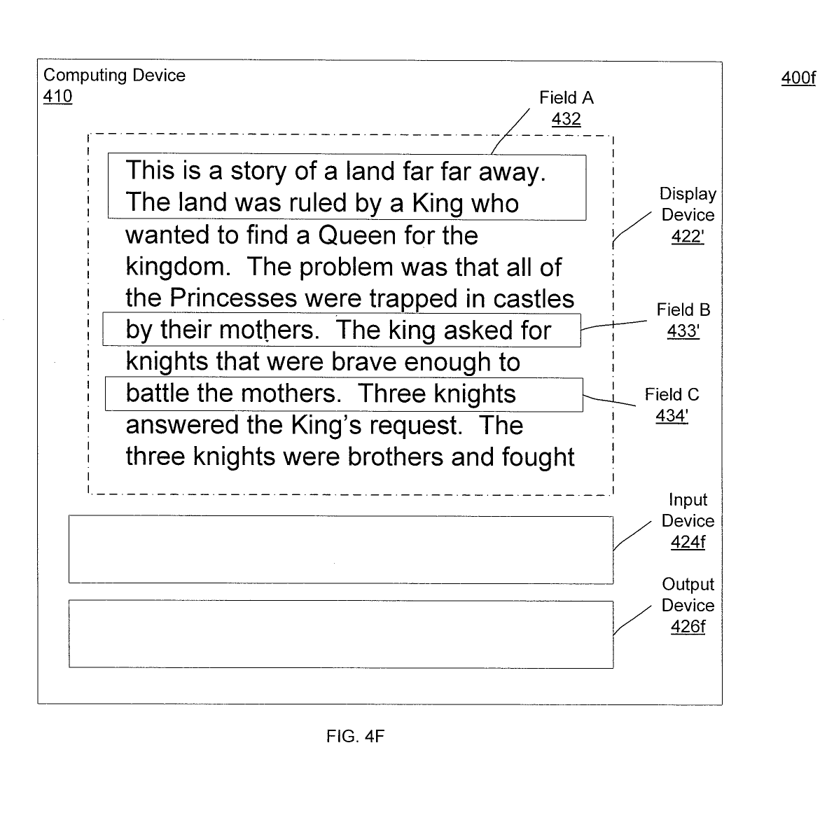

FIGS. 4A-4F depict exemplary user interfaces 400a-400f that utilize a computing device 410. Generally, in the user interfaces 400a-400f, the computing device 410 includes a display device 422, an input device 424, and an output device 426. The display device 422 illustrates a field A 432, a field B 433 and a field C 434. The user can interact with the user interfaces 400a-400e to access an application (e.g., word processor, spreadsheet, web browser, accounting application, order entry application, calculator, etc.) and/or the operating system and can focus on a location of the user interaction in the user interface 400a-400f via a focus location 440.

FIG. 4A depicts the exemplary user interface 400a. The input device 424a and the output device 426a are empty in the user interface 400a since there is not an active focus location, for example, the user has not selected a defined field. The field A 432 depicts two lines, the field B 433 depicts one line, and the field C 434 depicts one line in an text file (e.g., word processing file, plain text file, etc.). In other words, the defined field can be, for example, a part of an expanded area (e.g., a line in a multiple line text file, a line in a multiple line dialog box, etc.).

FIG. 4B depicts the exemplary user interface 400b. In the user interface 400b, the focus location 440b is set to the field B 433. The display module 115 of FIG. 1 determines the defined field based on the focus location 440b. For example, the focus location 440b is at a set of coordinates in the user interface and the display module 115 queries the application and/or the operating system to determine what is at that set of coordinates (in this example, the field B 433 is at the set of coordinates of the focus location). As another example, the focus location 440b is a line number in the user interface (e.g., line six, lines six and seven, etc.) and the display module 115 queries the application and/or the operating system to determine the expanded text at that line.

Based on the focus location 440b, the text module 112 determines expanded text associated with the defined field (in this example, “by dragons. The king asked for”). For example, the text module 112 queries the application and/or the operating system to determine the expanded text associated with field B 433 (e.g., the text module 112 sends a window refresh query to the application requesting a refresh of the text in the defined field). As another example, the text module 112 analyzes the user interface 430b to determine the expanded text from the data in the main memory (e.g., data at main memory 025a).

The contraction module 114 contracts the expanded text based on the context of at least one part of the expanded text (in this example, “by dragons4 ,! k+ask$=”). The output device 426b outputs the contracted text (e.g., outputs the contracted text in contracted Braille via a Braille output device).

FIG. 4C depicts the user interface 400c. In the user interface 400c, the focus location 440c is set to the field B 433. The input device 424c receives modified contracted text—“0_! “ms4 ,! k+ask$=”. The modified contracted text can be output to the output device 426c (e.g., for confirmation of the input)—“0_! “ms4 ,! k+ask$=”.

FIG. 4D depicts the user interface 400d. In the user interface 400d, the focus location 440d is set to the field C 434. When the focus location changes from focus location 440c in user interface 400c to the focus location 440d in the user interface 400d, the expansion module 113 expands the modified contracted text received from the input device 424c for the field B 433 based on a context of at least one part of the modified contracted text—“by their mothers. The king asked for”. The computing device 410 stores the modified expanded text (e.g., overwrites the original expanded text). As illustrated in the user interface 400d, the field B 433′ displays the modified expanded text—“by their mothers. The king asked for”

When the focus location 440c changed to the focus location 440d based on the user's interaction with the user interface, the display module 115 determines the defined field (in this example, the field C 434) based on the focus location 440d. The text module 112 determines that the field C 434 includes expanded text and retrieves the expanded text—“battle the dragons. Three knights”—(e.g., from video memory, from main memory, from hard drive, from flash drive, etc.). The contraction module 114 contracts the expanded text based on a context of at least one part of the expanded text (e.g., each word delineated by the spaces). The output device 426d outputs the contracted text—“battle ! dragons4 ,?ree kni<ts”.

FIG. 4E depicts the user interface 400e. In the user interface 400e, the focus location 440e is set to the field C 434. The input device 424e receives modified contracted text—“battle ! “ms4 ,?ree kni<ts” The modified contracted text can be output to the output device 426d (e.g., for confirmation of the input)—“battle ! “ms4 ,?ree kni<ts”.

FIG. 4F depicts the user interface 400f. In the user interface 400f, there is not an active focus location (e.g., the application is processing after the user hit Enter, the application is saving the file, etc.). Based on the change from focus location 440e in user interface 400e to the no focus location in the user interface 400f, the expansion module 113 expands the modified contracted text received from the input device 424e for the field C 434 based on a context of at least one part of the modified contracted text—“battle their mothers. Three knights”. The computing device 410 stores the modified expanded text. As illustrated in the user interface 400f, the field C 434′ displays the modified expanded text—“battle their mothers. Three knights”.

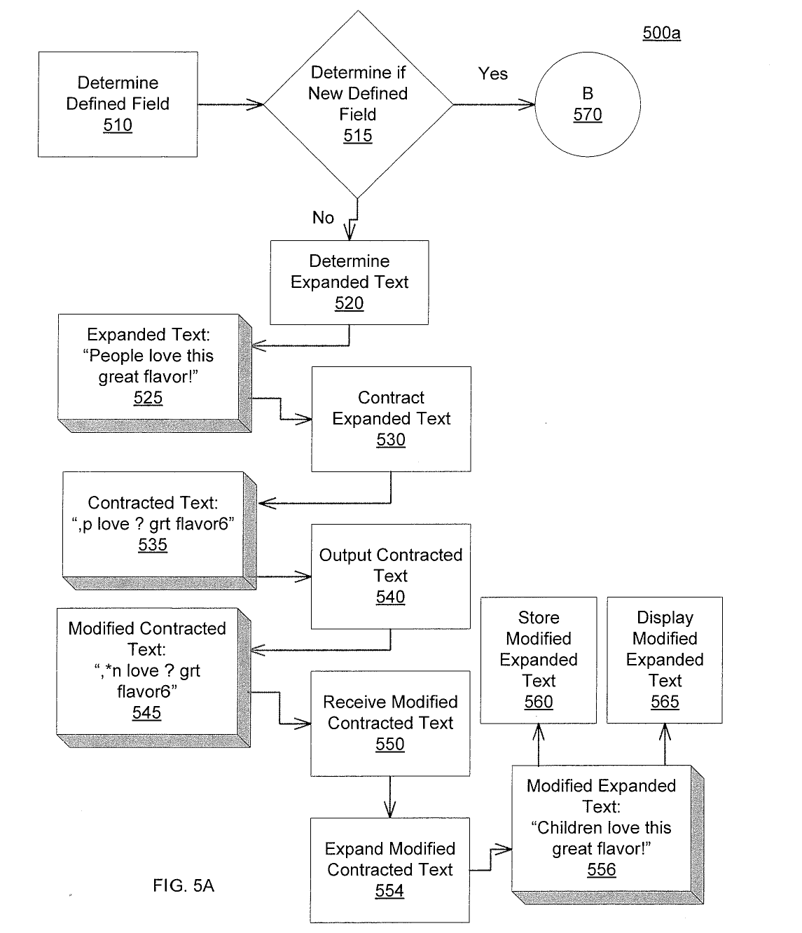

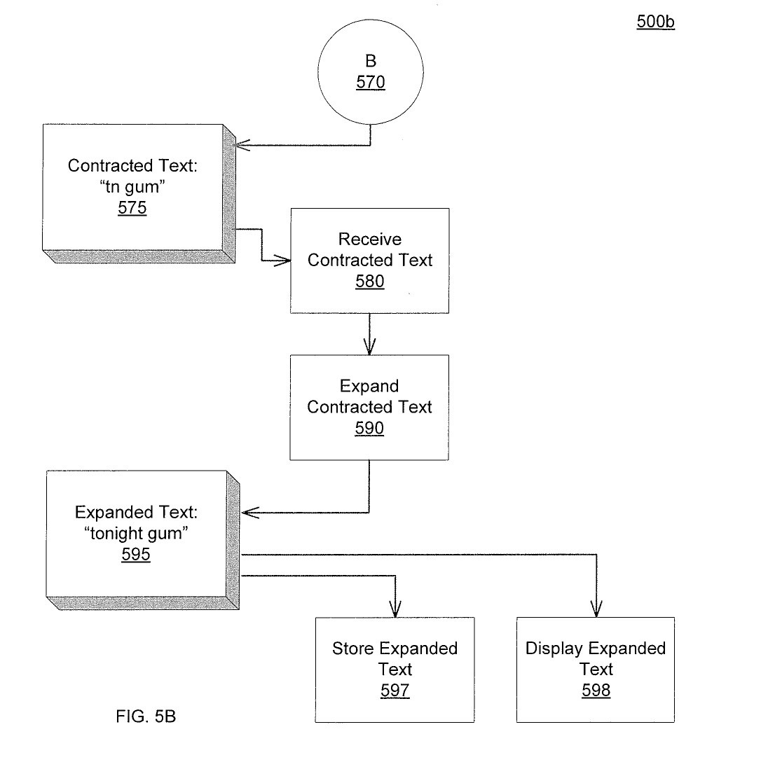

FIGS. 5A and 5B depict an exemplary flow chart of contracted Braille contraction and expansion utilizing, for example, the computing device 110 of FIG. 1. The display module 115 determines (510) a defined field based on a focus location. The display module 115 determines (515) if the defined field is a new defined field. If the defined field is not a new defined field, the text module 112 determines (520) expanded text associated with the defined field. The expanded text, as illustrated in the user interface 300a of FIG. 3A, is the “People love this great flavor!” 525. The contraction module 114 contracts (530) the expanded text based on a first context of at least one part of the expanded text. The output device 326b outputs (540) the contracted text 535—“,p love ? grt flavor6”. The input device 326c receives (550) the modified contracted text 545—“,*n love ? grt flavor6” The expansion module 113 expands (554) the modified contracted text to form the modified expanded text 556—“Children love this great flavor!” The storage device 126 stores (560) the modified expanded text and the display device 121 displays (565) the modified expanded text.

If the display module 115 determines the defined field is new, the processing continues (570) to the flow chart 500b. The input device 122 receives (580) the contracted text 575—“tn gum”. The expansion module 113 expands (590) the contracted text to form the expanded text 595—“tonight gum”. The storage device 126 stores (597) the expanded text and the display device 121 displays (598) the expanded text.

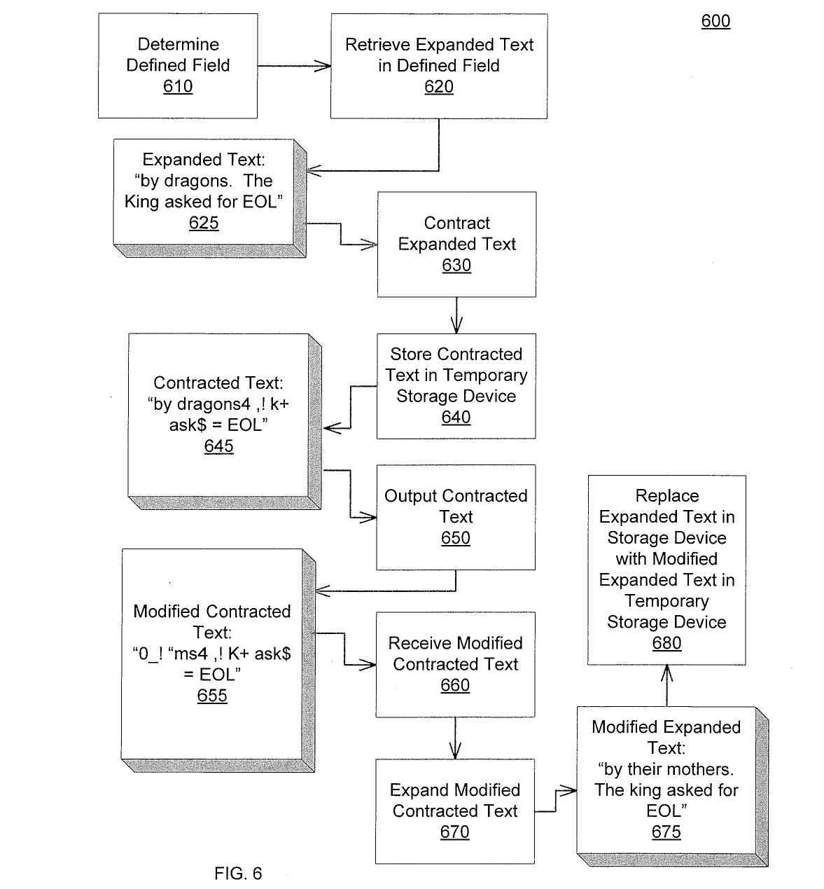

FIG. 6 depicts another exemplary flow chart 600 of contracted Braille contraction and expansion utilizing, for example, the computing device 110 of the FIG. 1. The display module 115 determines (610) a defined field based on focus location. The display module 115 retrieves (620) the expanded text in the defined field 625—“by dragons. The king asked for EOL”. The contraction module 114 contracts (630) the expanded text based on a context (e.g., spaces, end of line (EOL), etc.).

The temporary storage device 127 stores (640) the contracted text 645—“by dragons4 ,! k+ask$=EOL”. The output device 123 outputs (650) the contracted text (e.g., for editing purposes, etc.). The input device 122 receives (660) the modified contracted text—“0_! “ms4 ,! k+ask$=EOL”. The expansion module 113 expands (670) the modified contracted text 675—“by their mothers. The king asked for EOL”. The storage device 126 replaces (680) the expanded text in the storage device 126 with the modified expanded text in the temporary storage device.

In some examples, the display module 115 determines (610) a defined field based on focus location and/or the text at an end of the contracted text. In this example, the display module 115 coordinates with the text module 112 to retrieve (620) the expanded text in the defined field 625—“by dragons. The king asked for EOL”—to a specified expression (e.g., EOL, word, letter, punctuation, double colons, etc.). For example, the defined field starts after the EOL in the line above the illustrated defined field 625 and ends after the EOL.

In other examples, the storage device 126 determines the storage location of the expanded text at the storage device, for example, by querying a storage management module (not shown), determining the storage location from a storage look-up list, etc. The storage device 126 can replace (680) the expanded text in the storage device 126 with the modified expanded text based on the storage location at the storage device 126.

In some examples, the text module 112 determines the expanded text associated with the defined field by intercepting a message between the application and the operating system. For example, the application determines the expanded text associated with a text box and sends a message to the operating system to display the expanded text. The operating system module 124 can intercept the message, extract the expanded text from the message, contract the expanded text to contracted text, insert the contracted text into the message, and send the modified message to the operating system for output.

In other examples, the expansion module 113 determines the context of at least one part of the contracted text based on the text on at least one side of the part of the contracted text. For example, the expansion module 113 utilizes the text on either side of each part of the contracted text—“,e fr ne$s a hug6”—to determine the context. The expansion module 113 can separate the contracted text into parts, as illustrated in Table 1, based on a predefined parsing term (e.g., space, tab, comma, colon, paragraph mark, etc.) and/or a dynamically determined parsing term (e.g., most common character in the contracted text, least common character in the contracted text, etc.). As illustrated in Table 1, the expansion module 113 utilizes spaces and punctuation to separate the contracted text into parts and utilizes the text on a side of the contracted text to determine the context of the contracted text for expansion of the contracted text.

TABLE 1
Parts of Contracted Text (Spaces indicated by •)

| Parts of | Text on | Parts of Expanded |
|---|---|---|
| Contracted Text | Side | Text |
| ,e• | • | Every• |
| fr• | • | friend• |
| ne$s• | • | needs• |
| a• | • | a• |
| hug | ! | hug |
| 6 | NA | ! |

In some examples, the contraction module 114 determines the context of at least one part of the expanded text based on the text on at least one side of the part of the expanded text. For example, the contraction module 114 utilizes the text on either side of each part of the expanded text—“Every friend needs a hug!”—to determine the context. The contraction module 114 can separate the expanded text into parts, as illustrated in Table 2, based on a predefined parsing term (e.g., space, tab, comma, colon, paragraph mark, etc.) and/or a dynamically determined parsing term (e.g., most common character in the contracted text, least common character in the contracted text, etc.). As illustrated in Table 2, the contraction module 114 utilizes spaces and punctuation to separate the expanded text into parts and utilizes the text on a side of the expanded text to determine the context of the expanded text for contraction of the expanded text.

TABLE 2
Parts of Expanded Text (Spaces indicated by •)

| Parts of Expanded | Text on | Parts of |
|---|---|---|
| Text | Side | Contracted Text |
| Every• | • | ,e• |
| friend• | • | fr• |
| needs• | • | ne$s• |
| a• | • | a• |
| hug | ! | hug |
| ! | NA | 6 |

In some examples, the context is determined by the expansion module 113 and/or the contraction module 114 by analyzing part or all of the contracted text or expanded text, respectively. For example, the contraction module 114 analyzes a group of words within the expanded text to determine the contracted text for the group of words. In this example, the contraction module 114 contracts the expanded text—“to the friend”—to the contracted text—“6! fr”. In this example, the contraction module 114 analyzes each group of words—“to the” and “the friend”—to determine if either group can be contracted. As illustrated, the first group—“to the”—can be contracted to “6!”. As another example, the contraction module 114 analyzes the complete expanded text to determine the contracted text. In this example, the contraction module 114 contracts the expanded text—“by their”—to the contracted text—“0_!”. In this example, the contraction module 114 analyzed the complete expanded text—“by their”—to determine if the entire expanded text can be contracted.

In other examples, the expansion module 113 expands the contracted text and/or the contraction module 114 contracts the expanded text based on a list of contractions (e.g., look-up table, dictionary, array, etc.). For example, the list of contractions includes friend=fr. Table 3 illustrates an exemplary list of contractions.

TABLE 3
List of Contractions

| Expanded Text | Contracted Text |
|---|---|
| ally | ally |
| although | al? |
| As | z |
| beyond | 2y |
| every | e |
| friend | fr |
| from | f |
| people | p |
| rather | r |
| us | u |

In some examples, the focus location includes coordinates (e.g., line 5, column 4, 3×2, etc.) of the defined field. For example, the display module 115 determines the defined field based on the line number of the active window (in this example, line 9 of the text file in the active word processor window).

In other examples, the input device 122 receives the modified contracted text as text input from the user. For example, the user inputs text on the Perkins-style Braille keyboard.

In some examples, the storage device 126 determines a storage location of the expanded text at the storage device 126 and/or replaces the expanded text stored at the storage location with the modified expanded text stored in the temporary storage device 127 (e.g., a buffer, a video buffer, random access memory, etc.) based on the focus location request. The focus location request can be, for example, the interception of the user's request to change the focus location from the first focus location in the user interface to the second focus location in the user interface. The replacement of the expanded text with the modified expanded text can be, for exampled, initiated by the change in the focus location from the first focus location to the second focus location and the replaced text is associated with the defined field associated with the first focus location.

In other examples, the storage device 126 stores text at a storage location at the storage device 126. The storage location can be associated with the defined field. For example, the storage location is a database entry location for the text in the defined field (in this example, the storage location is product entry A45 based on the text box for product entry A45).

Although FIG. 1 illustrates the storage device 126 and the temporary storage device 127, the computing device 110 can utilize a single storage device or a plurality of storage devices. For example, the computing device 110 can store modified text in the same storage device as the original text. As another example, the computing device 110 stores part of the text in a part of the storage device 126 (in this example, memory designated as video memory) and stores the other part of the text in a different part of the storage device 126 (in this example, memory designated as main memory).

Although FIG. 1 illustrates the display device 121, the computing device 110 can, for example, not include the display device 121. In other words, the output of contracted text, uncontracted text, and/or any other information can utilize the output device 123 (e.g., Braille display, Braille printer, etc.). For example, the computing device 110 is a personal computer system with no display monitor, i.e., the display device 121.

In other examples, the defined field includes a field in a text box, a line in a file, and/or any other type of definable field (e.g., area on a user interface, a paragraph, a tab delimited area, etc.). The defined field can be, for example, delimited by an end of line delimiter (e.g., EOL, newline, etc.).

In some examples, the technology described herein enables the entering of Grade II Braille into a single-line field of a dialog box (in this example, the defined field is the single-line field of the dialog box). The characters entered can appear, for example, in the edit field in their contracted form until the user switches focus out of that field (in this example, the switching of the focus out of the field is the change in the focus location). The operating system module 124 of FIG. 1 can intercept a WM_KILLFOCUS message and the expansion module 113 can expand the Grade II Braille text into its uncontracted form and replace the field contents therewith. Visually the field contents can switch from being meaningless characters to being standard text. If the user moves back to the aforementioned field (in this example, the user changes the focus location back to the single-line field of the dialog box), upon interception of the WM_SETFOCUS message by the operating system module 124, the contraction module 114 can contract the standard text into Grade II Braille text and replace the uncontracted contents of the field with the equivalent Grade II form.

In other examples, the operating system and/or the application include an application programming interface (API) that enables replacement of text with modified text (e.g., new text, edited text, etc.). The API can be, for example, integrated into the operating system messaging (e.g., edit control messaging, richedit control messaging, etc.) and/or the application messaging.

In some examples, the technology described herein enables the two-way translation of text with a granularity of a single line (e.g., a single line of expanded text is contracted, a single line of contracted text is expanded, etc.). In this example, if the user is navigating through a text file reading information, then the text is output at contracted text (e.g., Grade II Braille). When a user adds/removes text from the line currently shown on the Braille display in Grade II Braille (in this example, the defined field is the line currently shown), the Grade II contents can be, for example, copied to an off-screen buffer (in this example, the temporary storage device) in which text can be advantageously deleted and new text can be added in Grade II Braille without changing the on-screen representation. When the user presses a navigation key on the Braille display that would navigate away from the line being edited (in these examples, changes the focus location via the user interaction), the Grade II text is converted back to an uncontracted form, and the original line of the document is replaced with this modified one. The text of the document can, for example, not change until after the focus location changes, i.e., the user navigates to a different line or part of the user interface.

In other examples, the operating system and/or the application include an API that enables replacement of a single line of text with modified text (e.g., new text, edited text, etc.). This API can be, for example, integrated into the operating system messaging (e.g., an object model API, a word processing API, etc.) and/or the application messaging.

In some examples, the applications and/or the operating system do not have to be modified to enable the expansion and contraction of text. For example, the technology is installed on a personal computer utilizing an operating system (e.g., Microsoft® Windows, Linux compatible operating system, Mac OS X, etc.), and the technology advantageously enables the input of contracted Braille into any application operating on the operating system by intercepting messages to/from the user interface (e.g., messages between the operating system and the application associated with the user interface).

Although the technology is described herein translating (e.g., contracting, expanding, etc.) between contracted Braille text and uncontracted Braille text, the technology can translate between any type of contracted text and uncontracted text. For example, the technology can be utilized to translate between acronyms and plain text (e.g., [symbol] to smiley face and vice versa). An advantage of the contraction and expansion based on focus location is that the contraction and expansion does not occur as the user types in the text, but occurs based on the movement to/from the focused locations which enables the user to more efficiently edit the text, i.e., the user does not have to re-type the contracted form, but can simply edit the contracted form. In other words, if the user is typing in contracted Braille text, e.g., *n, the expansion does not occur after the *, but occurs after the focus location has changed, thereby enabling the expansion to occur for the complete contracted Braille text input, e.g., *n to children.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device, for execution by, or to control the operation of, data processing apparatus. The implementation can, for example, be a programmable processor, a processing device, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer, on multiple computers at one site, and/or on multiple computers at multiple sites.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and/or software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include, can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a text to speech device, a Braille display, and/or a Braille embosser. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The computing device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a personal digital assistant (PDA).

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for bi-directional text contraction and expansion, the method comprising:
determining a defined field based on a focus location, the focus location associated with a location of the defined field in a user interface;
determining expanded text associated with the defined field;
contracting the expanded text based on a first context of at least one part of the expanded text; and
receiving modified contracted text, the modified contracted text associated with the defined field.

2. The method of claim 1 further comprising:
expanding the modified contracted text based on a second context of at least one part of the modified contracted text; and
storing the modified expanded text in a storage device.

3. The method of claim 2, wherein the storing the modified expanded text further comprising:
determining a storage location of the expanded text stored at the storage device; and
replacing the expanded text stored at the storage location at the storage device with the modified expanded text.

4. The method of claim 1 further comprising displaying the contracted text in the defined field.

5. The method of claim 1 further comprising determining the first context of at least one part of the expanded text based on the text on at least one side of the part of the expanded text.

6. The method of claim 1 further comprising determining the defined field based on a location of the expanded text in the user interface, the expanded text comprises part of an expanded text file.

7. The method of claim 1 further comprising:
expanding the modified contracted text based on a second context of at least one part of the modified contracted text; and
storing the modified expanded text in a temporary storage device.

8. The method of claim 7 further comprising:
receiving a focus location request based on a second focus location, the second focus location associated with a second location in the user interface;
determining a storage location of the expanded text stored at a storage device; and
replacing the expanded text stored at the storage location at the storage device with the modified expanded text stored in the temporary storage device based on the focus location request.

9. The method of claim 1 further comprising:
receiving a focus location request in the user interface; and
determining a storage location of the expanded text in the storage device based on the focus location request.

10. A method for bi-directional text contraction and expansion, the method comprising:
determining a defined field based on a focus location associated with a user interface; and
receiving contracted text, the contracted text associated with the defined field;
expanding the contracted text based on a context of at least one part of the contracted text and a second focus location; and
storing the expanded text at a storage location in a storage device, the storage location associated with the defined field.

11. The method of claim 10 further comprising determining the context of at least one part of the contracted text based on the text on at least one side of the part of the contracted text.

12. The method of claim 10 further comprising determining the defined field based on text at an end of the contracted text.

13. A computer program product, tangibly embodied in an information carrier, the computer program product including instructions being operable to cause a data processing apparatus to:
determine a defined field based on a focus location, the focus location associated with a location of the defined field in a user interface;
determine expanded text associated with the defined field;
contract the expanded text based on a first context of at least one part of the expanded text; and
receive modified contracted text, the modified contracted text associated with the defined field.

14. A system for bi-directional text contraction and expansion, the system comprising:
a display module configured to determine a defined field based on a focus location, the focus location associated with a location of the defined field in a user interface;
a text module configured to determine expanded text associated with the defined field;
a contraction module configured to contract the expanded text based on a first context of at least one part of the expanded text; and
an input device configured to receive modified contracted text, the modified contracted text associated with the defined field.

15. The system of claim 14 further comprising:
an expansion module configured to expand the modified contracted text based on a second context of at least one part of the modified contracted text; and
a storage device configured to store the modified expanded text.

16. The system of claim 14 further comprising:
a temporary storage device configured to store a modified contracted text; and
an expansion module configured to expand the modified contracted text based on a second context of at least one part of the modified contracted text.

17. The system of claim 16 further comprising:
the display module further configured to receive a focus location request based on a second focus location, the second focus location associated with a second location in the user interface; and
a storage device configured to:
determine a storage location of the expanded text; and
replace the expanded text stored at the storage location with the modified expanded text stored in the temporary storage device based on the focus location request.

18. A system for bi-directional text contraction and expansion, the system comprising:
a display module configured to determine a defined field based on a focus location associated with a user interface; and
an input device configured to receive contracted text, the contracted text associated with the defined field;
an expansion module configured to expand the contracted text based on a context of at least one part of the contracted text and a second focus location; and
a storage device configured to store the expanded text at a storage location, the storage location associated with the defined field.

19. The system of claim 18 further comprising the expansion module further configured to determine the context of at least one part of the contracted text based on the text on at least one side of the part of the contracted text.

20. A system for bi-directional text contraction and expansion, the system comprising:
means for determining a defined field based on a focus location, the focus location associated with a location of the defined field in a user interface;
means for determining expanded text associated with the defined field;
means for contracting the expanded text based on a first context of at least one part of the expanded text; and
means for receiving modified contracted text, the modified contracted text associated with the defined field.
